(19) United States
(12) Patent Application Publication
(10) Pub. No.: US 2017/0261263 A1
(43) Pub. Date: Sep. 14, 2017

(54) TAP ON A METALLURGICAL VESSEL, IN PARTICULAR ON AN ELECTRIC ARC FURNACE

(71) Applicant: Refractory Intellectual Property GmbH & Co. KG, Wein (AT)

(72) Inventors: Josse Bachmayer, Altmünster (AT); Karl Michael Zettl, Wien (AT); Markus Hochegger, Wein (AT)

(73) Assignee: Refractory Intellectual Property GmbH & Co. KG, Wein (AT)

(21) Appl. No.: 15/511,480

(22) PCT Filed: Aug. 25, 2015
(86) PCT No.: PCT/EP2015/069409

§ 371 Date: Mar. 15, 2017

(30) Foreign Application Priority Data
Sep. 17, 2014 (EP) 14185181.6

(51) Int. Cl. F27D 3/15; C21C 5/46; F27B 3/19

(52) U.S. Cl. CPC F27D 3/1518; F27B 3/19; F27D 3/15; C21C 5/4653; C21C 5/5211

(57) ABSTRACT

A tap on a metallurgical vessel, in particular an electric arc furnace, is provided with a refractory end brick (6) that has an outlet opening (10). There is assigned to the lower face surface (11) of the end brick (6) a slot (15) which is shaped such that with the latter a tear-off edge (16) is generated on the outlet opening (10) when emptying the vessel. This slot (15) is annular in form and is provided here with a radially outwardly inclined inclined surface (18), and this tear-off edge (16) is thus formed immediately following the outlet opening (10). Thus, after each tapping process, the tap can be cleaned without manual assistance by shearing off with the front edge of the plate of the closure device.

The invention relates to a tap on a metallurgical vessel, in particular an electric arc furnace, with a refractory end brick that has an outlet opening of the tapping channel.

These types of electric arc furnace are used to produce liquid crude steel. The furnace is equipped with a tap the tapping channel of which enables the liquid crude steel to run out of the furnace into a ladle or a similar metallurgical vessel by means of which the liquid crude steel can be conveyed for further processing.

As standard, the tap consists of sleeve-like individual segments lined up alongside one another, the segment at the outlet, which is located in a holding flange, being called the end brick. It is also known for these individual segments to be formed with so-called slots/keys which, however, have an annular section close to the external diameter and a bar close to the internal diameter.

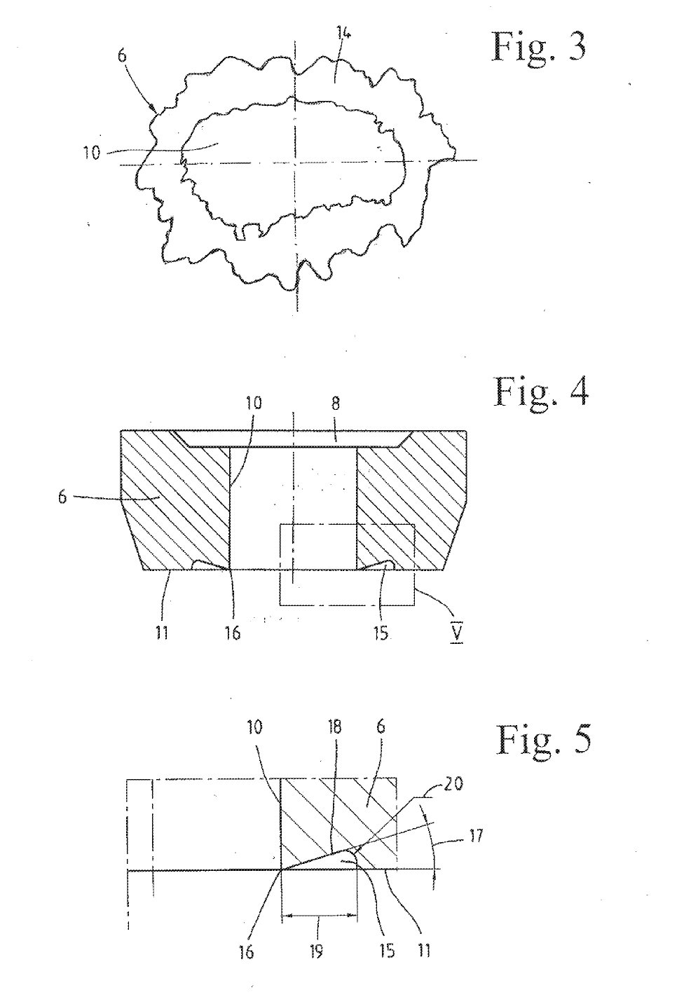

With an electric arc furnace it is generally necessary to close the tapping channel by means of a closure device because the tapping channel is filled with filler sand before the start of every melting process in the furnace. However, when the closure device is open there is the risk that crown-shaped frozen steel slag layers will be produced at the outlet of the tapping channel over the course of the tapping process (see FIG. 3) which may subsequently block the closure mechanism of the tap.

With conventional taps the crude steel flowing out during the tapping process tends to flow along the tear-off edge of the outlet contour of the end brick that is convexly rounded due to wear instead of being detached here and moving on in the flow direction predetermined by the tapping channel. This redirection of the flow direction encourages the formation of these crown-like frozen layers.

These frozen layers must be removed in order to enable closure. Many closure devices are equipped with a plate, the front edge of which shears off the frozen layers. If this is not possible, they must be chipped off manually using crowbars. In both cases the end brick of the tap is subjected to a considerable amount more mechanical wear, as the amount of wear increases, the frozen layers intensifying, and consequently, it becomes harder and harder to remove them.

In any case, it takes an effort to remove frozen layers from the end brick of the tapping channel manually, and so it is disadvantageous from a technical point of view because it reduces the frequency of consecutive tapping processes and so has a negative impact upon the productivity of the steel production plant. In addition, the frozen layers accelerate the mechanical wear of the end brick and so shorten the life span of the tap.

The object underlying the invention is to devise a tap of the type specified at the start which essentially works without manual removal of the frozen layers and, by simple means, makes it possible for the tap to have a longer period of use.

According to the invention, this object is achieved by the features of claim 1.

By means of the measure according to the invention of providing the refractory end brick of the tap with a tear-off edge which remains permanently intact, one can counter this tendency of the flow of steel to leave this flow direction predetermined by the tapping channel.

After every tapping process the tear-off edge can be cleaned without manual assistance by shearing off with the front edge of the plate of the closure device. This also results in a longer period of use for the end brick. However, this period of use crucially determines the efficiency of the tapping process and so is an important factor that also affects productivity.

In order to generate this permanently intact tear-off edge there is provided on the lower face surface of the end brick a slot the inclined surface of which is at an angle of between 5° and 20°, preferably 17°, in relation to the face surface.

Advantageously, the slot is rounded on the side facing away from the tear-off edge of the tapping channel, as viewed in cross-section. This contributes to the fact that the slot has practically no effect upon the structural stability of the refractory end brick.

The effect of the slot according to the invention can also be enhanced for special conditions of use by being enclosed by at least one additional slot that preferably has approximately the same profile, the two slots being able to have the same or different dimensions depending on the application.

In the following the invention will be explained in more detail by means of exemplary embodiments with reference to the drawings. These show as follows:

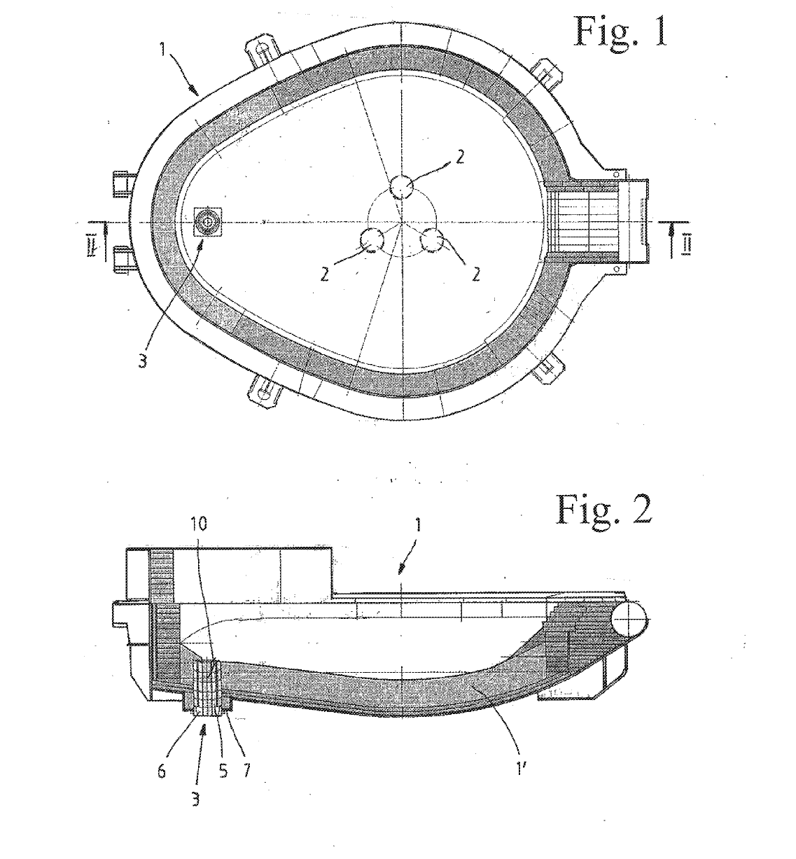

FIG. 1 is a top view of an electric arc furnace for the production of steel;

FIG. 2 is a longitudinal section of the electric arc furnace according to line II-II in FIG. 1;

FIG. 3 is a diagrammatically illustrated crown-like frozen steel slag layer on an end brick according to the prior art;

FIG. 4 is an end brick according to the invention, shown in section;

FIG. 5 is a detail V of the end brick according to FIG. 4, shown enlarged, and

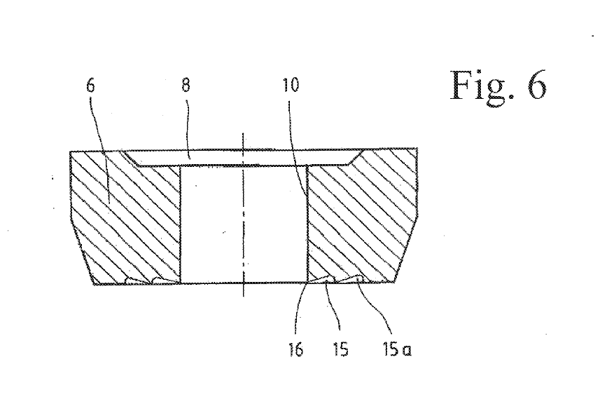

FIG. 6 is a section of another version of an end brick according to the invention.

FIG. 1 and FIG. 2 show a metallurgical vessel provided as an electric arc furnace 1 with three implied electrodes 2 and a tap 3 for the emptying of the latter. The electric arc furnace 1 is arranged here such that it can tilt so that the molten metal produced can be let out without leaving any residue. This tap 3 with a tapping channel 10 is contained in the refractory lining 1′ in the bottom of the furnace. The mode of operation of this electric arc furnace 1 is not discussed any further because this is known.

In principle, instead of an electric arc furnace 1 a different metallurgical vessel may also be provided, for example a converter or a tilting furnace for non-ferrous molten metal.

The tap 3 is formed from a number of sleeve-like refractory individual segments 5 lined up alongside one another and from an end brick 6 projecting from the furnace at the bottom and which is detachably fastened in a holding flange 7. The individual segments 5 and the end brick 6 are produced from a refractory material here, for example burnt or carbon-bonded magnesite or clay brick.

In FIG. 3 this type of three-dimensional crown-like frozen steel slag layer 14 is shown diagrammatically as an illustration, which on the known end bricks forms on the lower face side in every tapping process.

Before the start of a melting process the tapping channel 10 has to be closed every time so that it can be filled with filler sand. The closure is achieved by means of a closure device, the plate of which closes the tapping channel 10 at the outlet. Perfect closure is not guaranteed if frozen steel slag layers produced in the outlet region of the end brick 6 have built up and block the closure device.

In order to prevent this, the end brick according to the invention as shown in FIG. 4 and FIG. 5 is provided with a slot 15 running round the outlet opening and which forms a sharp tear-off edge 16 in the face surface 11 of the end brick 6. This prevents rounding of the outlet surface from occurring here which encourages the formation of frozen layers. Preferably, this tear-off edge 16 is formed immediately following the outlet opening 10.

As can be seen in FIG. 5, the slot 15, as seen in cross-section, is configured such that it has an inclined surface 18 that is inclined radially to the outside at an angle 17 of between 5° and 20°, preferably 17°, relative to the face surface 11 of the end brick. The radial width 19 of the slot 15 is from 2 to 10 cm, preferably 5 cm. The slot 15 is rounded on the side 20 facing away from the tear-off edge 16. It can be milled either by pressing the end brick or subsequently in the finished end brick.

The described geometry of the slot 15 has proven to be optimal if the tap is working under normal operating conditions. However, it goes without saying that it is also possible within the framework of the invention to vary the slot profile to a specific degree depending on the conditions of use if it guarantees the formation of a sharp tear-off edge without having any perceptible negative impact upon the structural stability of the end brick.

According to FIG. 6, as a variation of an end brick, provision can be made to increase the effect of the slot 15 by providing in the face surface 11 of the end brick at least one additional slot 15a which surrounds the slot 15 and is preferably formed with approximately the same profile.

The invention is sufficiently demonstrated by the above exemplary embodiments. Needless to say, it could also be explained by other versions. Thus, a slot with barely a part circle could be assigned to the lower face surface of the end brick. The end brick with the slot would have to be fitted here by this holding flange onto the electric arc furnace such that upon tilting the furnace, approximately half of the end brick would be provided with the slot or the tear-off edge on which the molten mass flows out.

1. A tap on a metallurgical vessel, in particular an electric arc furnace, with a refractory end brick (6) that has an outlet opening (10), characterized in that there is assigned to the lower face surface (11) of the end brick (6) a slot (15), which is shaped such that with the latter a tear-off edge (16) is generated on the outlet opening (10) when emptying the vessel.

2. The tap according to claim 1, characterized in that the slot (15) is annular in form and is provided thereby with a radially outwardly inclined inclined surface (18) which, as viewed in cross section, runs at an angle (17) of between 5° and 20° relative to the face surface (11) of the end brick (6), and this tear-off edge (16) is thus formed immediately following the outlet opening (10).

3. The tap according to claim 2, characterized in that the inclined surface (18) of the slot (15) is preferably inclined at an angle (17) of approximately 17° relative to the face surface (11) of the end brick (6).

4. The tap according to claim 1, wherein the slot is in the form of a part circle, preferably approximately half, and surrounds the outlet opening concentrically.

5. The tap according to claim 1, wherein depending on the dimensions of the tap, the slot has a radial width of 2 to 10 cm.

6. The tap according to claim 1, wherein the slot, which is made with a triangular cross section, is rounded on the side facing away from the tear-off edge.

7. The tap according to claim 1, wherein the slot is surrounded radially by at least one additional slot.

8. The tap according to claim 7, characterized in that both slots (15, 15a) are dimensioned with approximately the same profile or have different dimensions.

9. A refractory end brick for a tap according to claim 1, with an outlet opening, characterized in that there is assigned to the one face surface a slot which is shaped such that a tear-off edge is formed with said slot on the outlet opening.

10. The refractory end brick according to claim 9, characterized in that the slot (15) is made in the form of a circle or part circle and surrounds the outlet opening (10) concentrically.

11. The refractory end brick according to claim 9, wherein the slot is provided when shaping the end brick or is milled into the end block.

12. The refractory end brick according to claim 9, wherein edging is provided on the other face surface of the sleeve-like end brick in order to center the end brick.

13. The tap according to claim 2, wherein the slot is in the form of a semicircle and surrounds the outlet opening concentrically.

14. The tap according to claim 3, wherein the slot is in the form of a semicircle and surrounds the outlet opening concentrically.

15. The tap according to claim 2, wherein the slot has a triangular cross section and is rounded on the side facing away from the tear-off edge.

16. The tap according to claim 3, wherein the slot has a triangular cross section and is rounded on the side facing away from the tear-off edge.

17. The tap according to claim 4, wherein the slot has a triangular cross section and is rounded on the side facing away from the tear-off edge.

18. The tap according to claim 5, wherein the slot has a triangular cross section and is rounded on the side facing away from the tear-off edge.

19. The tap according to claim 2, wherein the slot is surrounded radially by at least one additional slot.

20. The tap according to claim 3, wherein the slot is surrounded radially by at least one additional slot.
